(19) United States
(12) Patent Application Publication
(10) Pub. No.: US 2004/0014861 A1
(43) Pub. Date: Jan. 22, 2004

(54) Extrusion aid combinations

(76) Inventors: Savvas Hatzikiriakos, Surrey (CA); Nimish Rathod, Vancouver (CA)

Correspondence Address: DOWELL & DOWELL PC, SUITE 309, 1215 JEFFERSON DAVIS HIGHWAY, ARLINGTON, VA, 22202

(21) Appl. No.: 10/452,934

(22) Filed: Jun. 3, 2003

Related U.S. Application Data
(60) Provisional application No. 60/384,397, filed on Jun. 3, 2002.
(60) Provisional application No. 60/384,402, filed on Jun. 3, 2002.

(51) Int. Cl. C08K 5/04

(52) U.S. Cl. 524/394; 524/544

(57) ABSTRACT

Thermoplastic compositions comprising a combination of extrusion aid additives, including a foam cell nucleating agent are provided as well as methods for their preparation and use. The compositions have improved extrusion and finished product characteristics for use in the manufacture of a variety of extruded articles including tubing and conductor coatings.

### PRIOR APPLICATIONS

This application claims the benefit of U.S. Provisional Patent Applications Nos. 60/384,397 and 60/384,402, both of which were filed Jun. 3, 2002 and both of which are incorporated herein by reference.

### FIELD OF THE INVENTION

This invention is in the field of aids for extruding thermoplastics.

### BACKGROUND OF THE INVENTION

Extruded thermoplastics arc used to make a variety of articles including wire coatings, tubes, bottles and films. In the process, melted thermoplastic is extruded and polymers useful in such applications are known as “melt processable” polymers, examples of which include polyolefins such as polyethylene and polypropylene, fluoropolymers and fluoroelastomers. In order to make the most efficient use of processing machinery used in thermoplastic extrusion, it is desirable for extrusion rates to be as high as possible. Nevertheless, a point is reached at which the surface of an extruded article begins to exhibit a “matte” appearance and begin to roughen. If tile extrusion rate increases further, more severe roughening appears (small amplitude periodic distortions) described as “surface melt fracture”, “land fracture” or “sharkskin”, and finally “gross melt fracture”. The latter describes distortions with magnitude of the same order of magnitude of the thickness of the extruded article i.e. thickness of the film or thickness of the tube. These phenomena and other aspects of surface distortions as the extrusion rates increase are discussed in Melt Rheology and its Role in Plastics Processing, J. M. Dealy and K. F. Wissbrun, Van Nostrand Reinhold, New York, 1990, pp.336-341, and in Mechanics of Polymer Processing, J. R. A. Pearson, Elsevier, N.Y. 1986, pp 184-197.

Various extrusion aids are known for use in delaying the onset of surface distortions in extruded articles comprising melt processable polymers, thereby permitting an increase in extrusion rates. Examples of such extrusion aids are fluoropolymer additives such as are described in U.S. Pat. Nos. 3,125,547; 4,904,735 and 5,707,569. Another category of extrusion aids are the foam cell nucleating agents, previously used in combination with a blowing agent in the production of foamed extrudates and subsequently described in U.S. Pat. No. 5,688,457 as permitting increased extrusion rates of melt processable polymers which are not foamed. U.S. patent application Ser. No. 09/740,285 published Dec. 6, 2001 describes use of the combination of a small amount of foam nucleating agent with a fluoroelastomer or fluoropolymer in a melt processable polymer to further improve smoothness of extruded articles and use of increased extrusion rates.

In addition to extrusion aids, other additives are known for use in thermoplastic extrusion. Examples include pigments, antioxidants, acid scavengers, light stabilizers, slip agents and lubricants. An example of acid scavengers and lubricants are fatty acids, fatty acid derivatives and carboxylic acid derivatives which may be used as a salt of a divalent or trivalent metal. Examples include calcium stearate and zinc stearate. In some cases, such lubricant, acid scavengers have been reported to decrease extrusion pressure during processing and to make the process of extrusion more efficient through lubrication of the flow of polymers. Examples of metallic stearates providing such a property are described in Plastics Additives, Gachter and Muller, Hanser, N.Y. (1996) 4^{th} Edition, pp. 465. An example of the use of one thermoplastic to increase efficiency of processing of another thermoplastic was described by Rosenbaum, E. et al (1995) Flow Implications in the Processing of Teflon® Resins; Intern Polym Proc. 204-212 (where a small amount of polyethylene was used to more efficiently process fluoropolymers and fluoroelastomers).

### SUMMARY OF THE INVENTION

This invention is based in part upon recognition that the use of a combination of extrusion aids, one of which being a foam cell nucleating agent, can result in a failure to realize extrusion efficiency possible from the use of the combination of extrusion aids unless the melt processable polymer composition is prepared with a view to ensuring that at least of a portion of a second extrusion aid does not effectively interact with the foam cell nucleating agent prior to combination with the melt processable polymer used in the composition. In cases where a second extrusion aid comprises a nonpolar component which may be adsorbed onto the foam cell nucleating agent, it is advantageous to combine components of a melt processable polymer composition in such a way as to allow for at least a part of the second additive to combine with the melt processable polymer while the portion of the second additive has not had an opportunity to adsorb to the foam cell nucleating agent. Accordingly, one aspect of the invention provides a process for preparing a melt processable composition comprising a melt processable polymer first and second, the first being a foam cell nucleating agent and the second aid having a nonpolar component which is capable of being absorbed onto a foam cell nucleating agent, wherein the process comprises combining at least a portion of the second additive with the melt processable polymer while said portion has not interacted with the first additive.

In the process of this invention, the portion of a second additive may be combined with a melt processable polymer while the portion has not interacted with a foam cell nucleating agent by alternate methodologies. In some embodiments, first and second additives are combined prior to combining of the additives with the melt processable polymer in a molten state with the second additive being combined in an amount in excess of the amount of the first additive. In other embodiments, one of the first and second additives is combined with the melt processable polymer in a molten state prior to combining the other of the first and second additives. In other embodiments, the first additive is combined with the melt processable polymer in a molten state prior to combining the second additive. The latter embodiments may be advantageous because proportions of the first and second additives in the composition may vary independently. In other embodiments, the second additive is combined with the melt processable polymer in a molten state prior to combining the first additive. In the latter embodiments, it is preferable that proportions of the first and second additives in the composition be about equal or that the second additive be in excess of the first additive.

In the process of this invention, a preferred foam cell nucleating agent is boron nitride.

In some embodiments of the process of this invention, the melt processable polymer is a fluoropolymer, a fluoroelastomer or a combination thereof, and the second additive is a polyolefin.

In other embodiments of the process of this invention, the second additive is a lubricant. Such lubricant comprises a nonpolar component and may comprise an alcohol, carboxylic acid or ester moiety. Such lubricants may be a fatty acid or fatty acid derivative such as lubricants comprising a stearate. Stearate lubricants for use in this invention may be metallic stearates, including calcium stearate or zinc stearate.

Embodiments of the process of this invention in which the second additive is a lubricant are particularly advantageous for use where the melt processable polymer is a polyolefin in such as a polyethylene or a polypropylene.

In some embodiments, the process of this invention further comprises extruding a melt processable composition to provide an unfoamed thermoplastic article such as a tube or a coating for a wire conductor.

Other aspects of this invention provide novel compositions comprising melt processable polymers and at least two additives that function as extrusion aids with one of the additives being a foam cell nucleating agent. In some embodiments, a second additive is a lubricant. In other embodiments, the second additive is a polyolefin and the melt processable polymer of the composition is a fluoropolymer, a fluoroelastomer or combination thereof.

In some embodiments, this invention provides a composition comprising a melt processable polymer and at least two additives, a first additive being a foam cell nucleating agent, and the second additive being a lubricant. The lubricant may comprise a nonpolar component and a component comprising an alcohol, carboxylic or ester moiety. In some embodiments, the lubricant comprises a stearate, which may be a metallic stearate such as calcium or zinc stearate. The melt processable polymer may be a polyolefin such as a polyethylene or a polypropylene. A preferred foam cell nucleating agent is boron nitride.

Other embodiments of this invention provide a composition comprising a melt processable polymer, and at least two additives, the polymer being a fluoropolymer, or a fluoroelastomer or a combination thereof, a first additive being a foam cell nucleating agent and a second additive being a polyolefin. The melt processable polymer may comprise polytetrafluoroethylenes/hexafluoropropylene. A preferred foam cell nucleating agent is boron nitride. The polyolefin additive may comprise a polyethylene.

In the methods and compositions of this invention, the melt processable polymer or combination of melt processable polymers are a major component and the additives are present as minor components. In some embodiments, melt processable compositions of this invention comprise relatively high levels of additives with such a composition being intended to be diluted in further melt processable polymer to achieve a final desired concentration of additives. Typically, some additives are present in a composition with a melt processable polymer at about 0.001 to about 10 wt % of the composition, with the amounts of the additives being independently variable. Preferably, a final concentration of additives in a composition of this invention will find the additives present at about 0.01 wt % to about 5 wt %, or more preferably at about 0.01 wt % to about 2 wt %.

Other aspects of this invention provide processes of extrusion of compositions of this invention as well as shaped articles, including tubes and wire conductor coatings comprising compositions of this invention.

### BRIEF DESCRIPTION OF THE DRAWINGS

FIG. 1 is a graph comparing the effect of boron nitride and polyethylene on the flow curves of the fluoropolymer FEP®4100 obtained by means of a circular extrusion die.

FIG. 2 is a graph comparing the effect of the combination of polyethylene and boron nitride on the flow curve of fluoropolymer FEP®100 obtained by means of a crosshead extrusion die.

FIG. 3 is a graph comparing the effect of the combination of polyethylene and boron nitride on the flow curve of fluoropolymer FEP®4100a metallocene linear low-density polyethylene (Exacte® 3128) obtained by means of a crosshead extrusion die.

FIG. 4 is a graph comparing the effect of boron nitride and calcium stearate on the flow curves of metallocene linear low-density polyethylene (Exact™ 3128) obtained by means of a crosshead extrusion die.

### DETAILED DESCRIPTION OF THE INVENTION

The term “melt processable composition” refers to a polymeric composition which may be melted and extruded without foaming. Such compositions comprise “melt processable polymers” as a principle component. Melt processable polymers for use in this invention include any polymer that may be extruded at temperatures below its decomposition temperature (degradation temperature). Such polymers include polyolefins such as high-density polyethylene, linear low density polyethylene having a specific gravity of 0.89 to 0.92, isotactic polypropylene and other thermoplastic polymers known in the art. Linear low density polyethylenes made with metallocene catalysts such as INSITE® catalyst technology of Dow Chemical Company and the polymers marketed under EXACT® and EXCEED® trademarks by the ExxonMobil Corporation may be used in the present invention. The later resins are called metallocene polyethylenes.

The melt processable polymer used in the invention can be a single polymer or a blend of polymers. Examples of blends of several polyolefins can be found also in “Plastics for Engineers, H. Domininghaus, Hanser, N.Y. (1993) pp.23-125.

Foam cell nucleating agents effective in the present invention include inorganic or organic materials which are thermally stable under the conditions of extrusion; do not liberate anything that causes bubble formation. Preferably the foam cell nucleating agent is solid under extrusion conditions but may partially dissolve in a molten polymer during extrusion.

Examples of inorganic foam cell nucleating agents are described in U.S. Pat. No. 5,688,457 and U.S. Ser. No. 09/740,285 and include boron nitride, talc, metal oxides such as MgO, Al₂O₃, and SiO₂, calcium carbonate, and calcium, zinc, sodium or potassium tetraborates. Boron nitride, commonly known as hexagonal boron nitride or graphite-like boron nitride, is a preferred foam cell nucleating agent and is available from St. Gobain Advanced Ceramics Corp., (preciously known as Carborundum Corp) Amherst, N.Y.

Examples of organic foam cell nucleating agents are also described in U.S. Pat. No. 5,568,457 and Ser. No. 09/740,285 and include low molecular weight polytetrafluoroethylene. Additional examples include fluorinated sulfonic and phosphonic acids and salts such as Telomer™ B sulfonic acid having the formula F(CF₂)ₙCH₂CH₂SO₃H, where n is an integer from 6 through 12. Particular types of Telomer™ B are identified by the predominant value of the integer “n”. For example, BaS-10 is the barium salt of the sulfonic acid in which n=10 in the predominant chain length present. Hydrocarbon sulfonic or phosphonic acids are also effective in lower melting thermoplastic polymers, such as polyethylene and polypropylene. The salts of these are identified in a similar way. For example, BaS-3H is barium propane sulfonate and KS-1H is potassium methane sulfonate. The eight-carbon perfluorinated sulfonic acid available as Fluororad™ FC-95 can also be used.

A variety of lubricants are effective as extrusion aids in the invention. Calcium stearate, zinc stearate, aluminum stearate, sodium stearate, potassium stearate, magnesium stearates, and others. Other important classes of lubricants which can provide the same lubricating effects in combination with a foam cell nucleating agents are fatty alcohols and their dicarboxylic acid esters, fatty acid esters of glycerol and other short-chain alcohols, fatty acids, fatty acid amides, oligomeric fatty acid esters, fatty alcohol fatty acid esters, natural and synthetic paraffin waxes, and montanic acid, its esters and soaps. All these classes of lubricants are defined in Plastics Additives, Gachter and Muller, Hanser, N.Y. 1996 4^{th} Edition, pp. 465. List of trade-names and supplies are also given in the same reference (Plastics Additives, Gachter and Muller, Hanser, N.Y. 1996 4^{th} Edition, pp. 476-479). All these materials will referred to as lubricants in this specification.

A number of polyolefins are effective as extrusion aid additives for the extrusion of fluoropolymers and fluoroelastomers and other melt processable polymers, including linear low density polyethylene, high density polyethylene, linear density polyethylene and others. Polypropylenes of all types may also be used. In the processing of polyolefins, a polyolefin used the extrusion aid additive should be incompatible (immiscible) with the processable or bulk polyolefin and should have a smaller molecular weight. Use of lower molecular weight and or immiscible polyolefin as the extrusion aid makes it possible to reduce the extrusion/processing pressure of fluoropolymers and polyolefins as a result of a lubrication effect. Polyethylene and polypropylene waxes (very small molecular weights normally less than 10,000 kg/k-mole) can easily provide such a lubrication effect (Plastics Additives, Gachter and Muller, Hanser, N.Y. 1996 4^{th} Edition, pp. 465).

At least one foam nucleating agent and other extrusion aid addition are used in combination according to this invention, but more than one of either or both may be used. They can be added to the polymer in the extruder or can be dry-mixed therewith prior to extrusion, the goal in either case being to obtain a uniform distribution of the nucleating agent within the molten polymer at least just prior to extrusion.

However, there is a strong interaction between a foam cell nucleating agent such as boron nitride, and a melt processable polymer or another component such as a lubricant comprise a nonpolar effect. For example, stearates have a low surface energy of about 18.6 mJ/m² and are essentially nonpolar components. The surface energy of a foam cell nucleating agents will typically, vary, for example, boron nitride comprises a nonpolar component of about 36±2 mJ/m² and a nonpolar component which varies from 9 to 27 mJ/m². Such nonpolarity gives rise to interactions between the foam cell nucleating agent, the melt processable polymer and/or the lubricants. For example, polyolefin molecules adsorb readily onto boron nitride particles, so in order to obtain the synergism from the combination of the two extrusion aids (e.g. boron nitride and a stearate) on processability, complete interaction between stearates and boron nitride is prevented by the methods and processes of the invention. If boron nitride powder and a stearate or a polyolefin additive were to be merely added together to the melt processable polymer, interaction between the two will prevent stearates from diffusing to the interface with a wall of the exterior and provide proper lubrication. The melt processable polymer adsorbs onto the boron nitride and therefore keep the boron nitride particles mainly within the body of the melt processable composition. Simultaneous presence of both stearates and boron nitride in relating equal amounts will create agglomerations of both components and this will have an negative impact in the elimination of the sharkskin melt fracture as well as in the elimination of gross melt fracture.

In a first method, the foam cell nucleating agent is first added to the melt processable polymer (such as polyolefin) and either a masterbatch (concentrate) or the final desired concentration of the melt processable polymer can be thus prepared. This will assure a complete saturation of the adsorption sites of the nucleating agent with molecules of the melt processable polymer and a complete dispersion and incorporation of the addition into the body of the melt processable polymer. In a second step, the second extrusion aid additive such as the stearate or a polyolefin is added into the melt processable polymer that already contains the nucleating agent either directly into the concentrate or into the melt processable polymer having its final desired concentration.

The first method described above is preferred because it permits the use of amounts of foam cell nucleating agent and second extrusion aid additive which may vary independently and the amounts may be independently selected to provide particular results with a particular melt processable polymer forming the bulk of the resulting composition. In an alternate to the first method, the order of addition of the additives is reversed with the second additive being combined with melt processable polymer prior to combination of the foam cell nucleating agent. In the first method, it may be advantageous to make use of an excess of the second additive as compared to the amount of foam cell nucleating agent despite the use of a stepwise addition of the additives in situations where the relative costs of the additives are such that the cost of the foam cell nucleating agent exceeds that of the second additive. This is typically the case for example when the foam cell nucleating agent is boron nitride and the second additive is a stearate.

In a second method, if both processing aid components are desired to be added simultaneously, the second additives are added in excess amounts as compared to the nucleating agent. For example, at least 60 wt % of stearates and 40 wt % of boron nitride should be used when the concentrations of the two components are compared. More preferably 75 wt % of stearates and 25 wt % of boron nitride should be used when the concentrations of the two components are compared. Even more preferably 90 wt % of stearates and 10 wt % of boron nitride should be used when the concentrations of the two components are compared. Even higher relative amounts of a polyolefin extrusion aid can be used, although the results in terms of processability deteriorate as relative concentration of nucleating agent decreases.

In using the second method, it may be convenient to make a “master batch” or concentrate comprising the second additive together with the foam cell nucleating agent plus some of the melt processable polymer to be extruded. Such a concentrate may have ten or more times the concentration of additives than will be present in the extruded polymer with the second additive being in excess as described above.

The concentrations of foam cell nucleating agent and second additive useful as a combined extrusion aid are independently about 0.001 weight % (wt %) to 10% wt %, preferably independently about 0.001 wt % to 5 wt %, and more preferably independently 0.01 wt % to about 1 or 2 wt %, when they are prepared according to the first method. When the second method is used the concentration of the second additive should be in excess as described above. In a concentrate, the concentration of second additive and foam nucleating agent useful as a combined extrusion aid may be independently about 0.01 wt % to 10%, so as to accommodate dilution or “let down” of the concentrate to achieve concentration levels of the processing aid components to within the useful concentration ranges disclosed above. Weight % is based on the total weight of polymer plus polyolefin processing aid and foam cell nucleating agent.

In certain aspects of the invention, useful polymers are fluoropolymers and fluoroelastomers such as polytetrafluoroethylene (PTFE), polytetrafluoroethylene-hexafluoropropylene (TFE/HFP), polyvinylfluoride (PVF), polyvinylidene-fluoride (PVDF or PVF₂), perfluoroalkoxy copolymers (PFA), polyolefins such as high-density polyethylene, linear low density polyethylene having a specific gravity of 0.89 to 0.92, metallocene polyethylenes and isotactic polypropylene and other thermoplastic polymers. Examples of fluoropolymers, fluoroelastomers and polyolefins can be found in “Plastics for Engineers, H. Domininghaus, Hanser, N.Y. 1993 pp.23-125 (polyolefins) pp.309-361 (fluoropolymers).

Products made from composition or by processes according to this invention can be generally described as shaped articles, and include films, sheet, tubing, wire coating or insulation, bottles, and other regular or irregular shapes that find use as seals and gaskets among other applications. In extrusion, a concentrate which has been prepared in two steps as described above (first method) or with an excess of second additive (second method) may be added to the melt processable polymer, which is usually in pellet or cube form, in an amount such that the final concentration of additives in the polymer will be within a desired range. The melt processable polymer and a concentrate may be mixed by shaking, tumbling or other means to ensure even distribution of the concentrate throughout the polymer. Alternatively, a concentrate may be metered into the extruder with the melt processable polymer pellets at a rate that will give the desired concentration of processing aid in the polymer.

The extrusion process of the present invention produces an unfoamed extrudate and unformed articles such as wire coating, tubing, film, sheet, and rods. By extrusion of an unfoamed polymer in the process of the present invention is meant that neither the extrudate nor its articles are foamed. The extrudate and articles obtained from the extrudate may have a small percentage of voids resulting from air or other gas entering the extruder with the polymer feed, but such articles will nevertheless contain no more than 5% voids and preferably less, e.g. less than 3% voids, which would not be considered “foamed” by those skilled in the art.

### EXAMPLES

The examples were referenced using a rheometer with either a circular die having a 90° entrance angle or an annular crosshead to mimic a wire coating process, in the manner described in U.S. application Ser. No. 09/740,285 condition of the surface of an extrudate was determined by visual observation. Under acceptable extrusion conditions, the surface of the extradate is glossy and smooth. Deterioration of the surface is observed as loss of glows and then the development of a rougher surface texture. The shear rate at which surface deterioration appears is defined here as the critical shear rate. Results are presented graphically in the drawings as apparent shear stress versus apparent shear rate which are standard rheological terms. Shear stress is a measure of the force or pressure drop needed to drive the extruded polymer through the die. It is associated with a corresponding shear rate. Shear rate is related to extrusion rate or flow rate of the polymer that is being extruded. Shear stress increases with shear rate, as would be expected: it takes greater force or pressure drop to move the polymer at a faster rate through the die. The shear stress/shear rate curves do not give information on the appearance of deterioration of surface smoothness or the development of sharkskin or other malformations of the extrudate. Therefore, onset of surface deterioration will be presented in Tables 1-4.

### Example 1

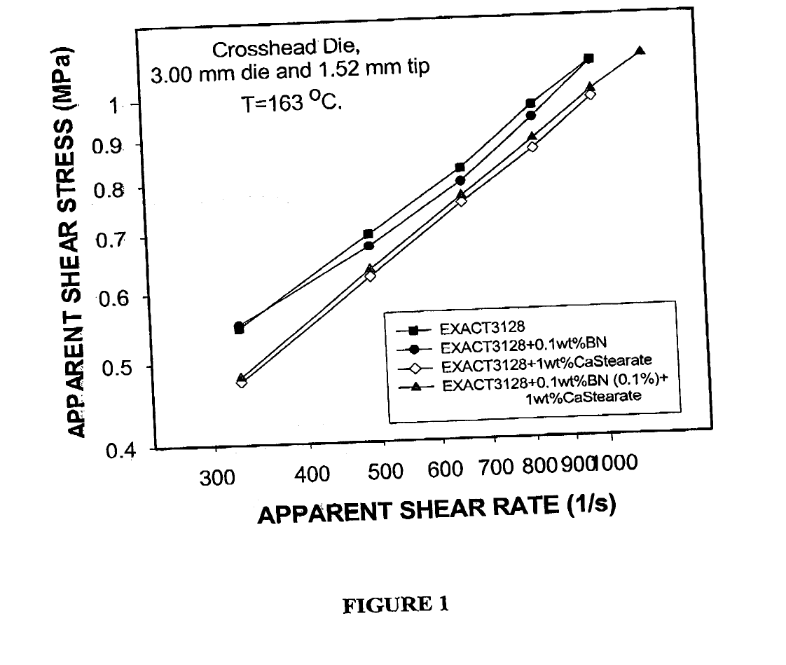

Example 1 shows the separate effects of polyethylene and the combination of polyethylene and boron nitride on the flow curve of FEP®4100 at 350° C. Extrusion was done using the capillary rheometer with a circular (capillary die) having a length to diameter ratio of 40 and diameter of 0.762 mm. FIG. 1 shows the apparent flow curves of a blend of FEP®4100 with 0.1% by weight of a finely dispersed linear low density polyethylene (GRSN/7047), and that of a blend of FEP®4100 with 0.1 wt % by weight of a finely dispersed linear low density polyethylene (GRSN/7047) and 0.1 wt % boron nitride (BN). It can be seen that the presence of the polyethylene dramatically decreases the shear stress practically over the whole range of apparent shear rates examined. Therefore, practically the extrusion becomes dramatically more economical. The onset of surface deterioration of pure FEP4100 is 80 s⁻¹. This becomes about 800 s⁻¹ with the use of 0.1% weight polyethylene leaving some “matteness” on the surface of the extruded product. The use of the combination of polyethylene (PE) and BN produces smooth and glossy surfaces up to a rate of 1,300 s⁻¹. Table 1 below summarizes the results.

TABLE 1
The effect of boron nitride and polyethylene on the melt fracture behaviour
of FEP ® 4100

| | Critical shear rate |
|---|---|
| | for the onset of |
| Polymer/Blend | surface deterioration |
| FEP ® 4100 | 80 s⁻¹ |
| FEP ® 4100 + 0.1 wt % PE | 800 s⁻¹ |
| FEP ® 4100 + 0.1 wt % PE + 0.1 wt % BN | 1,300 s⁻¹ |

From the results summarized in Table 1 it can be concluded that the combination of PE and BN is useful to increase the extrusion rate as well as reduce the energy needed for extrusion.

### Example 2

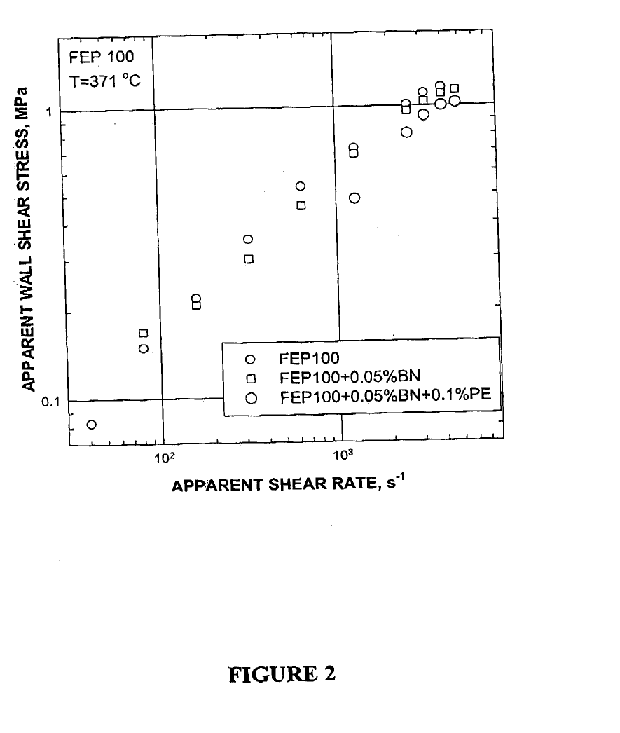

Example 2 shows the behavior of a fluoropolymer (FEP®100) alone, with BN and with the combination of PE and BN in extrusion. This example is illustrated in FIG. 2 where the three flow curves are plotted (wall shear stress versus shear rate). Shown are the flow curves of: FEP®100 alone; FEP®100 with the addition of 0.05% BN; and FEP®100 with the addition of 0.05 wt % BN and 0.1 wt % of PE (GRSN/7047). The test was run on the crosshead die attached to a rheometer. The effect of the different formulations on the timing of onset of surface deterioration is shown in Table 2 below. In addition, the use of PE in the combination decreases the extrusion pressure and therefore the extrusion becomes easier.

TABLE 2
The effect of boron nitride and polyethylene on the melt fracture behaviour
of FEP ® 100

| | Critical shear rate |
|---|---|
| | for the onset of |
| Polymer/Blend | surface deterioration |
| FEP ® 100 | 40 s⁻¹ |
| FEP ® 100 + 0.05 wt % BN | 3,200 s⁻¹ |
| FEP ® 100 + 0.1 wt % PE + 0.05 wt % BN | >4,000 s⁻¹ |

The combination of PE and BN is a useful processing aid increasing the extrusion rate as well as reducing the energy needed for extrusion.

### Example 3

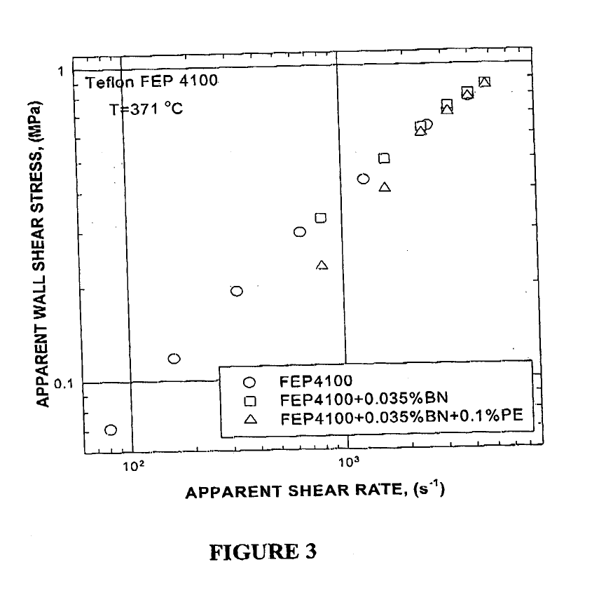

Example 3 shows the behavior of a fluoropolymer (FEP®4100) alone, with BN, and with the combination of PE and BN. This example is illustrated in FIG. 3 where the three flow curves are plotted (wall shear stress versus shear rate). The flow curve of FEP®4100 alone, the flow curve of FEP®4100 with the addition of 0.035% BN and the flow curve of FEP®4100 with the addition of 0.035 wt % EN and 0.1% of PE (GRSN/7047) are shown. The test was run on the crosshead die attached to a rheometer. Results in the onset of surface deterioration are summarized in Table 3 below. The use of polyethylene in the combination also decreased the extrusion pressure and therefore the extrusion becomes practically easier.

TABLE 3
The effect of boron nitride and polyethylene on the melt fracture behavior
of FEP ® 4100

| | Critical shear rate |
|---|---|
| | for the onset of |
| Polymer/Blend | surface deterioration |
| FEP ® 4100 | 350 s⁻¹ |
| FEP ® 4100 + 0.035 wt % BN | 3,200 s⁻¹ |
| FEP ® 4100 + 0.1 wt % PE + 0.035 wt % BN | 4,800 s⁻¹ |

It can be concluded that the combination of polyethylene (PE) and boron nitride is a useful processing aid, increasing the extrusion rate as well as reducing the energy needed for extrusion.

### Example 4

In this example, the behavior of a metallocene linear low-density polyethylene (Exact®3128) alone, with BN, with calcium stearate and with the combination of calcium stearate and BN in extrusion by using the crosshead die is shown. The BN was first incorporated into Exact® 3128 polyethylene by preparing an initial concentrate of 5 wt %, which was then diluted to a final concentration of 0.1 wt % BN. Pellets of Exact® 3128 having 0.1 wt % BN were mixed in dry form with calcium stearate. This way the Exact® 3128+1 wt % calcium stearate+0.1 wt % BN blend product was prepared. The Exact® 3128+1 wt % calcium stearate blend was prepared by dry mixing of Exact® 3128 polyethylene pellets with calcium stearate.

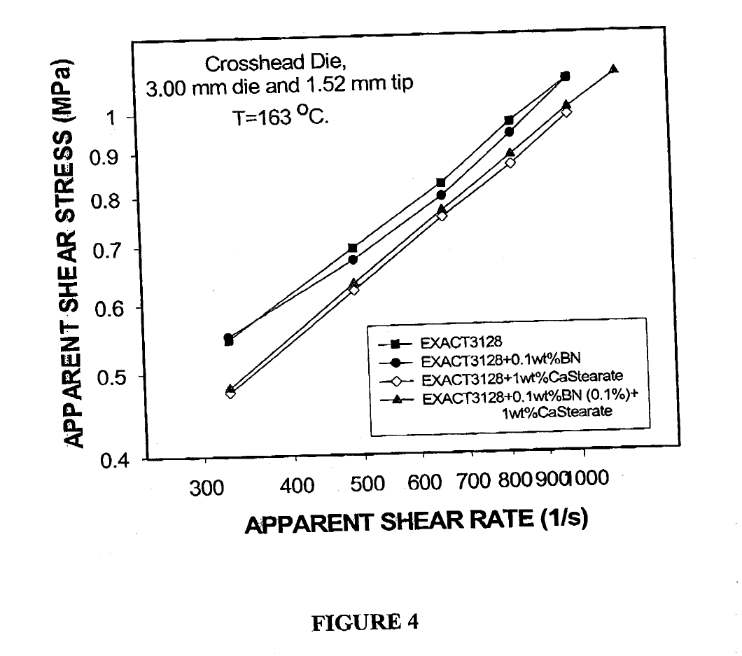

The four flow curves are plotted (shear stress versus shear rate) in FIG. 4. The flow curve of virgin Exact®3128, the flow curve of Exact®3128 with the addition of 0.1% BN, the flow curve of Exact®3128 with the addition of 1% calcium stearate and the flow curve of Exact®3128 with the addition of 0.1 wt % BN and 1% wt % of calcium stearate are illustrated. The test was run on the crosshead die attached to a rheometer. The results are summarized in Table 4 below. In addition, the use of calcium stearate in the combination with boron nitride decreases the extrusion pressure and therefore the extrusion becomes practically easier.

TABLE 4
The effect of boron nitride and calcium stearate
on the melt fracture behaviour of Exact ® 3128

| | Critical shear rate |
|---|---|
| | for the onset of |
| Polymer/Blend | surface deterioration |
| Exact ® 3128 | 40 s⁻¹ |
| Exact ® 3128 + 1 wt % Calcium Stearate | 327 s⁻¹ |
| Exact ® 3128 + 0.1 wt % BN | 490 s⁻¹ |
| Exact ® 3128 + 1 wt % Calcium stearate + | 1,145 s⁻¹ |
| 0.1 wt % BN | |

### Example 5

The experiment illustrated in Example 4 was repeated with zinc stearate in place of calcium stearate. The results were similar. The use of the combined processing aid (zinc stearate and BN) is a better processing aid than the use of BN, which in turn is a better processing than the zinc stearate alone. In addition, the use of the combined processing aid reduces the extrusion pressure compared to the extrusion pressure when the boron nitride is used alone.

Although the foregoing invention has been described in some detail by way of illustration and example for purposes of clarity of understanding, it will be readily apparent to those of skill in the art in light of the teachings of this invention that changes and modification may be made thereto without departing from the spirit or scope of the appended claims. All patents, patent applications and publications referred to herein are hereby incorporated by reference.

We claim:

1. A process for preparing a melt processable composition comprising a melt processable polymer and first and second additives, the first additive being a foam cell nucleating agent and the second additive having a nonpolar component and being capable of being absorbed onto a foam cell nucleating agent, wherein the process comprises combining at least a portion of the second additive with the melt processable polymer while said portion has not interacted with the first additive.

2. The process of claim 1, wherein the first and second additives are combined prior to combining with the polymer in a molten state, the second additive being combined in all amount in excess of the first additive.

3. The process of claim 1, wherein one of the first and second additives is combined with the polymer in a molten state prior to combining the other of the first and second additives.

4. The process of claim 3, wherein the first additive is combined with molten polymer prior to combining the second additive.

5. The process of claim 3, wherein the second additive is combined with molten polymer prior to combining the first additive.

6. The process of claim 3, wherein proportions of the first and second additives are about equal or the second additive is in excess of the first additive.

7. The process of claim 1, wherein the melt processable polymer is a fluoropolymer, fluoroelastomer or a combination thereof and the second additive is a polyolefin.

8. The process of claim 1, wherein the melt processable polymer is a polyolefin and the second additive is a polyolefin that is of lower molecular weight and is immiscible in the melt processable polymer.

9. The process of claim 8, wherein the first additive is boron nitride.

10. The process of claim 1, wherein the second additive is a lubricant.

11. The process of claim 10, wherein the lubricant comprises a nonpolar component and an alcohol, carboxylic acid or ester moiety.

12. The process of claim 11, wherein the lubricant is a fatty acid or fatty acid derivative.

13. The process of claim 12, wherein the lubricant comprises a stearate.

14. The process of claim 12, wherein the lubricant is a metallic stearate.

15. The process of claim 13, wherein the lubricant is calcium stearate or zinc stearate.

16. The process of claim 10, wherein the first additive is boron nitride.

17. The process of claim 16, wherein the melt processable polymer is a polyolefin.

18. The process of claim 1, further comprising extruding the melt processable composition to provide a thermoplastic article.

19. The process of claim 18, wherein the article is not foamed.

20. A composition comprising a melt processable polymer and at least two additives, a first additive being a foam cell nucleating agent, and a second additive being a lubricant.

21. The composition of claim 20, wherein the additives are each independently present at about 0.001 to about 10 wt %.

22. The composition of claim 20, wherein the foam cell nucleating agent is present at about 0.001 wt % to about 5 wt % and the lubricant is present at about 0.01 wt % to about 5 wt %.

23. The composition of claim 20 wherein the foam cell nucleating agent is present at about 0.001 wt % to about 2 wt % and the lubricant is present at about 0.01 wt % to about 2 wt %.

24. The composition of claim 20, wherein the melt processable polymer is a polyolefin.

25. The composition of claim 20, wherein the foam cell nucleating agent is boron nitride.

26. The composition of claim 10, wherein the lubricant comprises a nonpolar polar component.

27. The composition of claim 26, wherein the lubricant additionally comprises an alcohol, carboxylic acid or ester moiety.

28. The composition of claim 27, wherein the lubricant is a stearate.

29. The composition of claim 27, wherein the lubricant is a metallic stearate.

30. The composition of claim 27, wherein the lubricant is calcium or zinc stearate.

31. A shaped article comprising the composition of claim 20.

32. The shaped article of claim 31, wherein the article is a tube.

33. The shaped article of claim 31, wherein the article is a coating for a conductor.

34. A process of extrusion of a molten composition of claim 20.

35. A composition comprising a melt processable polymer and at least two additives, the polymer being a fluoropolymer, a fluoroelastomer or a combination thereof, a first additive being a foam cell nucleating agent, and a second additive being a polyolefin.

36. The composition of claim 35, wherein the additives are each independently present in the composition at about 0.001 wt % to about 10 wt %.

37. The composition of claim 35, wherein the additives are each independently at about 0.001 wt % to about 5 wt %.

38. The composition of claim 35, wherein the foam cell nucleating agent is present at about 0.001 wt % to about 2 wt % and the polyolefin additive is present at about 0.01 wt % to about 2 wt %.

39. The composition of claim 35, wherein the melt processable polymer is a polytetrafluoroethylene/hexafluoropropylene.

40. The composition of claim 35, wherein said foam cell nucleating agent is boron nitride.

41. The composition of claim 35, wherein the second additive is a polyethylene.

42. A shaped article comprising the composition of claim 35.

43. The shaped article of claim 42, wherein the article is a tube.

44. The shaped article of claim 42, wherein the article is a coating for a conductor.

45. A process of extrusion of a molten composition of claim 35.
